(19) United States
(12) Patent Application Publication
(10) Pub. No.: US 2019/0124905 A1
(43) Pub. Date: May 2, 2019

(54) ATTACHABLE APPARATUS FOR FISHING HOOK DEPOT

(71) Applicant: Myong Hee Kong, Los Angeles, CA (US)

(72) Inventor: Myong Hee Kong, Los Angeles, CA (US)

(21) Appl. No.: 15/796,691

(22) Filed: Oct. 27, 2017

(51) Int. Cl. A01K 97/06; A45F 5/02; B26B 11/00

(52) U.S. Cl. CPC A01K 97/06; B26B 11/00; A45F 5/02

(57) ABSTRACT

The disclosures of present invention (denoted as below, “Attachable Apparatus”) describes the improvement of currently marketed hook depot. The weakness of the currently marketed hook depot is that a fisherman cannot attach his hook depot to his body. The present invention is designed to overcome this weakness.

The present invention permits a fisherman to attach the Attachable Apparatus to his clothing or jacket by placing the clothing or jacket between a minus pole magnet and a plus pole magnet located in the upper back part of Attachable Apparatus, so that he could easily and quickly take out hooks from the fishing hook depot in order to replace an used hook with a new hook while he is fishing.

In addition, the present invention permits a fisherman to cut an used fishing line in order to replace an used fishing hook with a new fishing hook by putting the used fishing line into the magnetic knife while he is fishing with the Attachable Apparatus attached to his clothing or jacket.

### CROSS REFERENCE TO RELATED APPLICATIONS

Not Applicable

### FIELD

An attachable apparatus for fishing hook depot (denoted as “Attachable Apparatus” below) is provided and it can be used for a fisherman to attach it to his clothing or jacket. The present invention has a shape and characteristics, which permits a fisherman to easily take out hooks from the hook depot and attach a new hook to a fishing line while he is fishing. The hook depot, which is a part of the present invention, can be pulled long or short through two flexible strings which are connected to the present invention. The hook depot is also detachable from the present invention.

The present invention also permits a fisherman to cut an unnecessary fishing line connected to the fishing hook through the attached magnetic knife on the present invention without grabbing an independent fishing knife, so that a fisherman could fast and easily connect a new hook to a fishing line in order to catch another fish. The magnetic knife is also detachable from the present invention

### BACKGROUND

Preexisting Fishing hook depot in the market is very useful device which allows a fisherman to store fishing hooks, which makes it very convenient for a fisherman to easily find out the location of hooks and to carry them. However, the defect of the preexisting fishing hook depot in the market has been placed on the ground nearby or a fishing box nearby as detached from a fisherman's body while the fisherman is fishing.

With the preexisting fishing hook depot, in order to connect a new fishing hook to a fishing line, the fisherman first locate where the hook depot is and second, move his body to grab the hook depot and take out fishing hooks from the hook depot.

It could take long to find out the location of hook depot and attach a new hook to a fishing line. In addition, a fisherman could lose the hook depot easily as leaving it on the ground or somewhere else.

The present invention is devised to resolve such a defect above of the preexisting hook depot as making it possible for a fisherman to attach a fishing hook depot to his wearing clothing or jacket. Through the present invention, a fisherman could easily locate the fishing hooks and connect a new hook to a fishing line just in a few second.

The other defect of the preexisting hook depot is that it does not have a fishing knife attached to the hook depot, which causes an inconvenience to a fisherman since he should first find out the location of fishing knife in order to cut the unnecessary fishing line. It could take longer to cut an unnecessary fishing line with a fishing knife detached from the hook depot, compared to a fishing knife attached to the hook depot.

The present invention is also devised to resolve such an inconvenience above by the way of attaching the fishing knife to the hook depot. Through the present invention, a fisherman could easily locate a fishing knife and cut the unnecessary fishing lines in a few second so that the fisherman could catch more fishes in an limited amount of time compared to the preexisting hook depot with a fishing knife detached from the hook depot.

### SUMMARY

The present invention is a combination of a magnetic button set, a magnetic knife, a pullable plate for hook depot and a magnetic hook depot.

The magnetic button set is located in the upper back part of the present invention. The button is freely attachable or detachable. In the inner side of button, there is located a plus magnetic pole which is detachable or attachable and there is fixed a minus magnetic pole inside the upper back part of the present invention.

The magnetic knife is placed inside the hole located in the upper front part of the present invention. The magnetic knife is freely detachable and attachable. In the middle of the magnetic knife, there is located one magnet and in the squared space of the left-side wall inside the hole, there is the other magnet.

The pullable plate for hook depot is located in the down part of the front of the present invention. The pullable plate is connected to the present invention trough two flexible strings.

The magnetic hook depot is placed on the pullable plate by the help of trough the plus and minus pole magnet. The plus pole magnet is located in the middle of the back of the magnetic hook depot and the minus pole magnet is located in the middle of the front of the pullable plate.

The magnetic hook depot additionally has two connectable hooks located in the upper back part of the magnetic hook depot. Through two connectable hooks, the magnetic hook depot is hooked into two holes formed in the upper part of the pullable plate. Through the plus and minus pole magnets and two connectable hooks, the hook depot is freely attachable to or detachable from the pullable plate.

### BRIEF DESCRIPTION OF DRAWINGS

Various features, aspects and merits of present invention is better understood by referring to the attached drawings.

FIG. 1 shows a perspective view of the attachable apparatus for the fishing hook depot (as below, “Attachable Apparatus”)

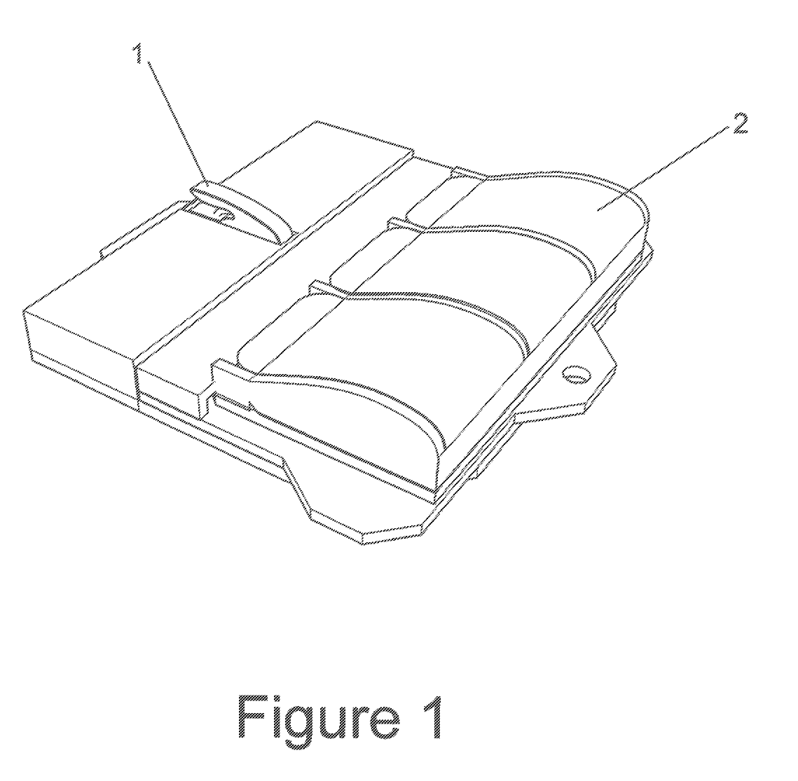

FIG. 2 shows a perspective view of the back of “Attachable Apparatus”

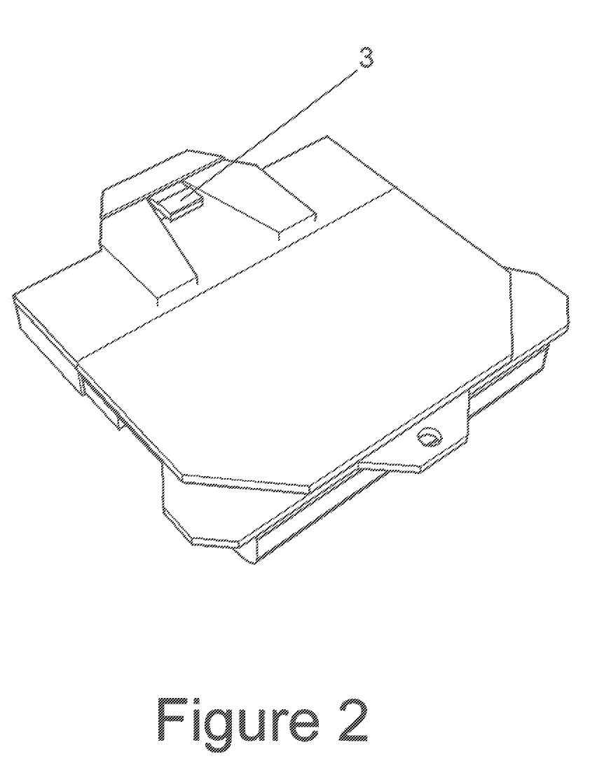

FIG. 3 shows a perspective view of the back of Attachable Apparatus” with a magnet button detached

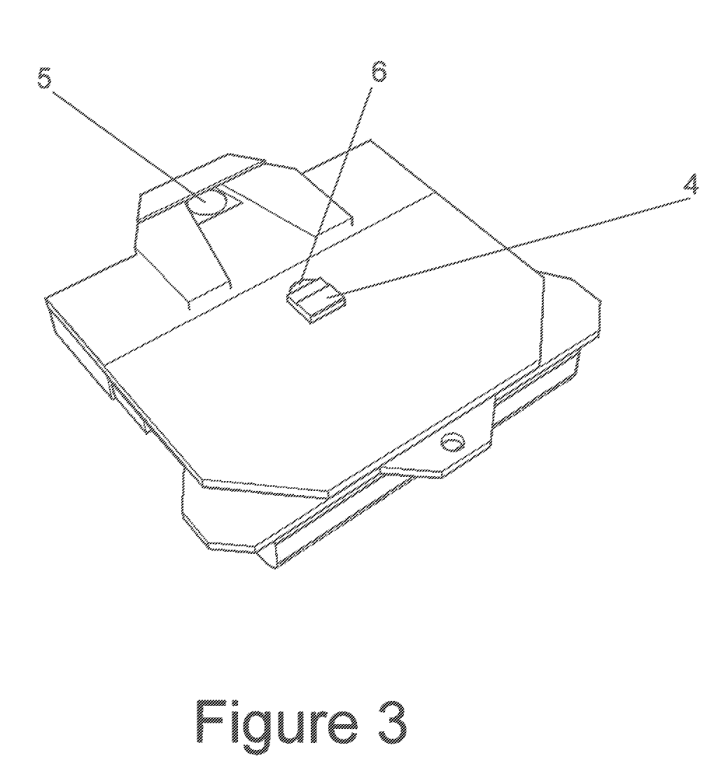

FIG. 4 shows a perspective view of “Attachable Apparatus” while the pullable plate for hook depot is pulled from “Attachable Apparatus” and the magnetic knife is detached from “Attachable Apparatus”

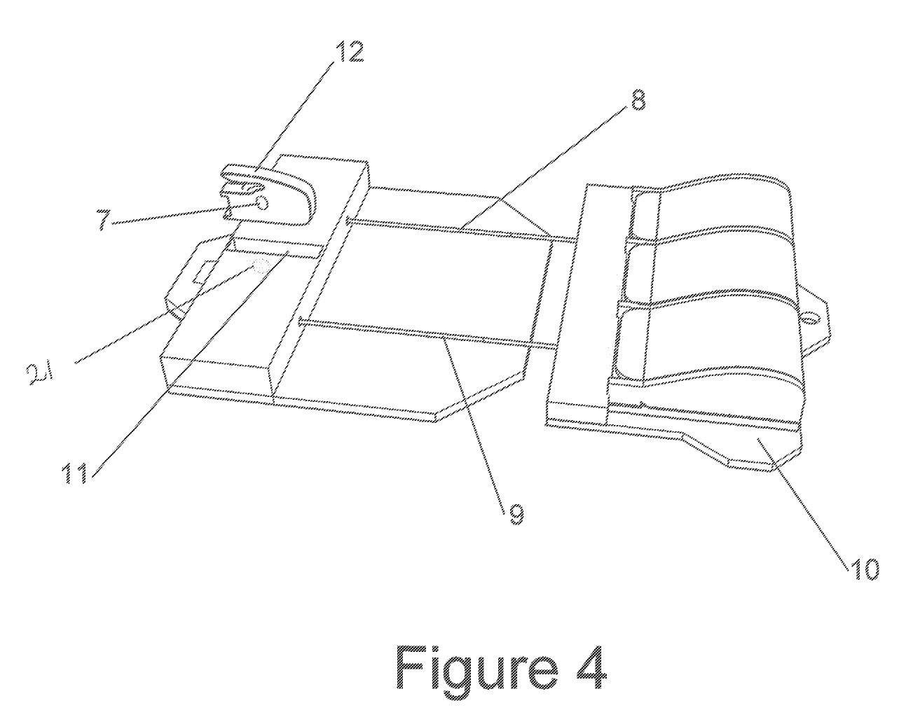

FIG. 5 shows a perspective view of “Attachable Apparatus” while the pullable plate for hook depot is pulled from “Attachable Apparatus,” the magnetic knife is detached from “Attachable Apparatus” and the fishing hook depot is detached from the pullable plate for the fishing hook depot.

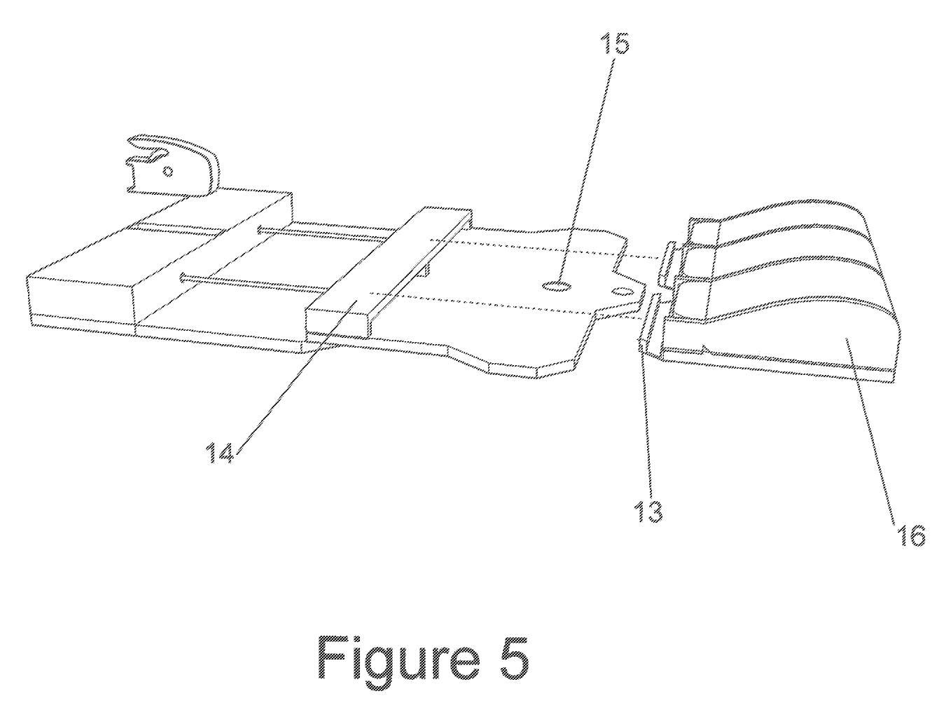

FIG. 6 shows a perspective view of the magnetic knife.

FIG. 7 shows a perspective view of the back of fishing hook depot detached from the pullable plate for fishing hook depot and a perspective view of “Attachable Apparatus” with the fishing hook depot detached from the pullable plate for fishing hook depot.

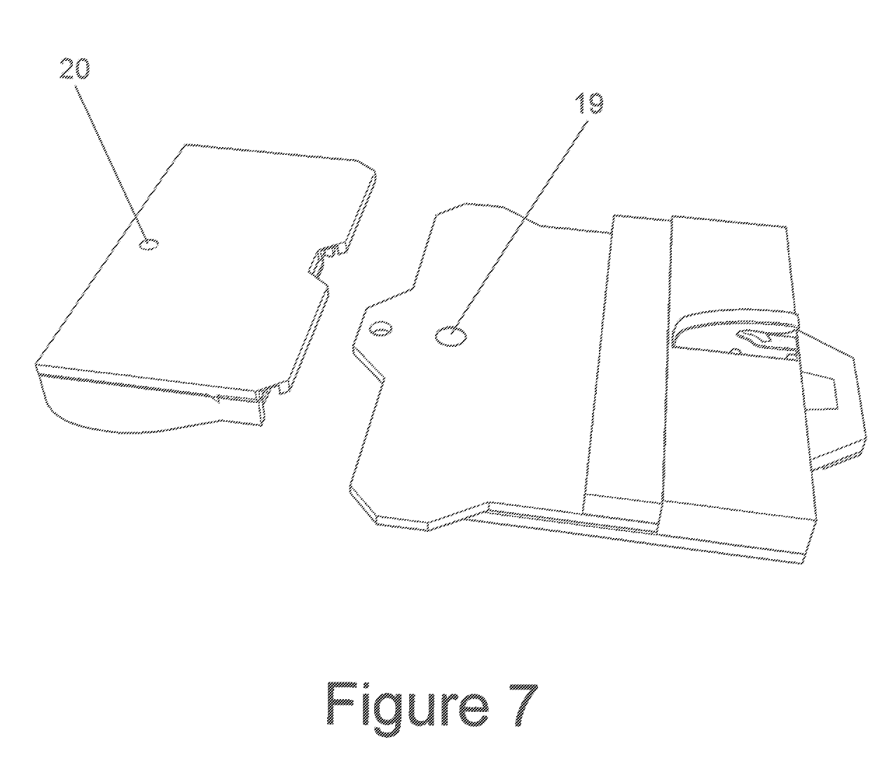

FIG. 8 shows a right-side perspective view of magnetic knife, wherein the magnet and the knife are detached as a fisherman pushes a pen into the hole located in the middle of right-side of magnetic knife.

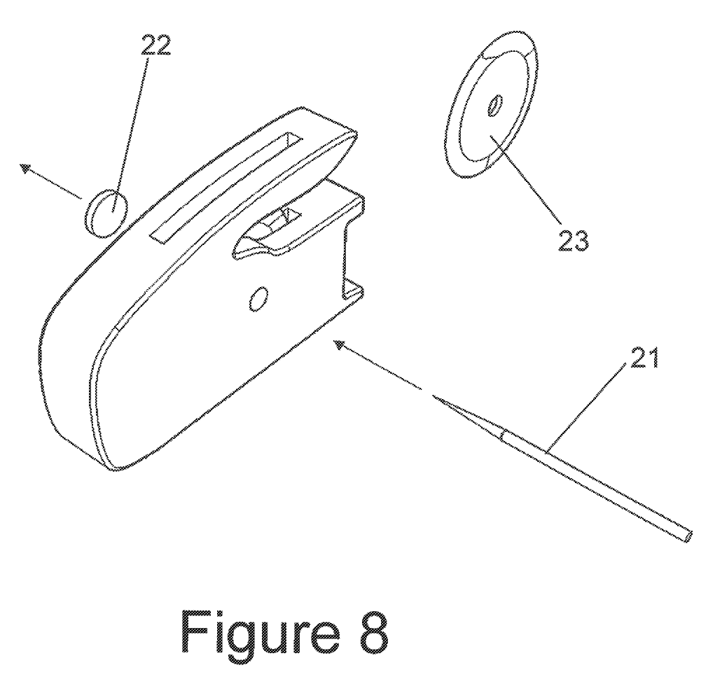

FIG. 9 shows a left-side perspective view of magnetic knife, wherein the magnet and the knife are detached as a fisherman pushes a pen into the hole located in the middle of right-side of magnetic knife.

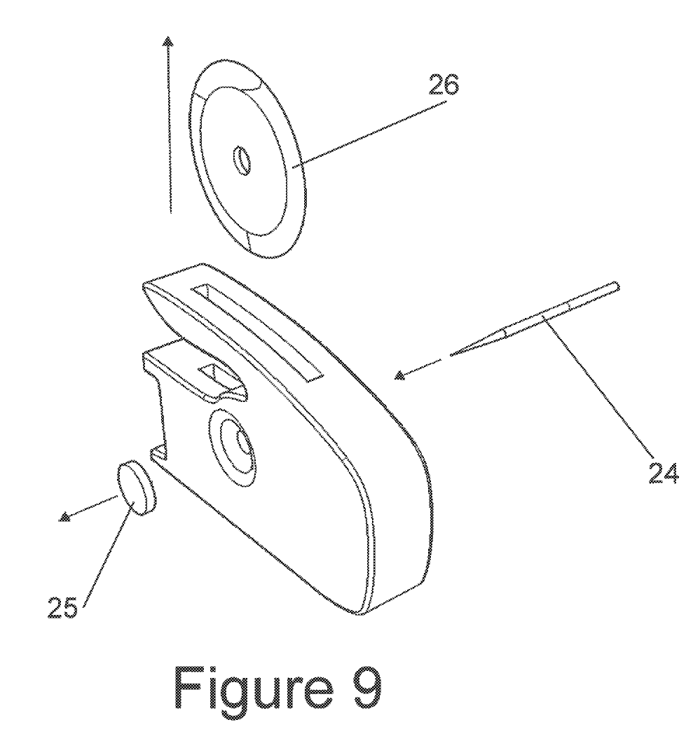

FIG. 10 shows a perspective view of Attachable Apparatus, wherein it shows one magnet in the squared space located in the left side of wall of the hole for the magnetic knife.

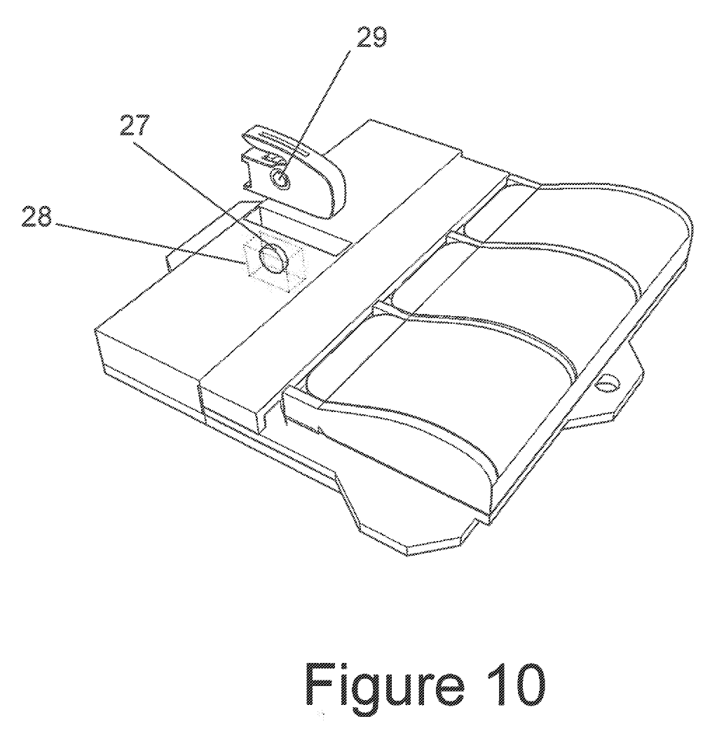

FIG. 11 shows combinations of both magnets, wherein, if one magnet in the magnetic knife faces the wall with a plus pole, the other magnet in the squared space faces the wall with minus pole and if one magnet in the magnetic knife faces the wall with a minus pole, the other magnet in the squared space faces the wall with a plus pole.

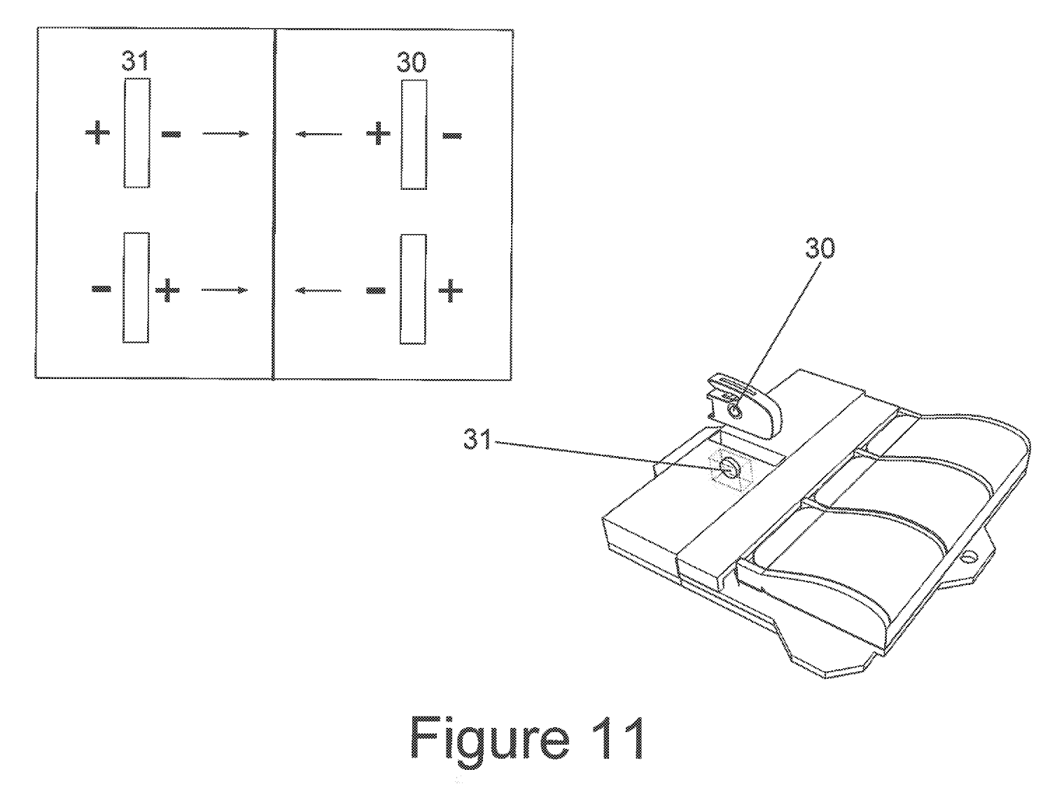

### DETAILED DESCRIPTION EMBODIMENTS OF INVENTION

The Attachable Apparatus comprises a magnetic knife 1,7, 12, fishing hook depot 2, 16, a magnetic button 3, 4, 5, 6 and the pullable plate for fishing hook depot (denoted as “pullable plate” below) 10, 14.

The magnetic knife 1 is attached into the hole 11 located in the upper front part of “Attachable Apparatus” and is detachable from the hole 11 because there is located one magnet 30 in the middle of the magnetic knife and the other magnet 31 in the squared space located in the left-side wall inside of the hole 11.

A fisherman could push a pen 21 into the hole in order to change a knife, in which the magnet 25 in the magnetic knife is detached. However, when a fisherman put a new knife into magnetic knife and reattach the magnet 25 on the magnetic knife, the magnet pole could change. Namely, a plus pole could face the left-side wall in the hole for the magnetic knife or a minus pole could face the wall in the hole for magnetic knife.

To cope with this kind of cases, the present inventor made a squared space 28 in which one magnet 27 could be placed, the width of which is less than one of squared space.

So, if one magnet in the magnetic knife faces the wall with a plus pole 30, the other magnet in the squared space comes to face the wall with minus pole 31 and if one magnet in the magnetic knife faces the wall with a minus pole 30, the other magnet in the squared space comes to face the wall with a plus pole 31.

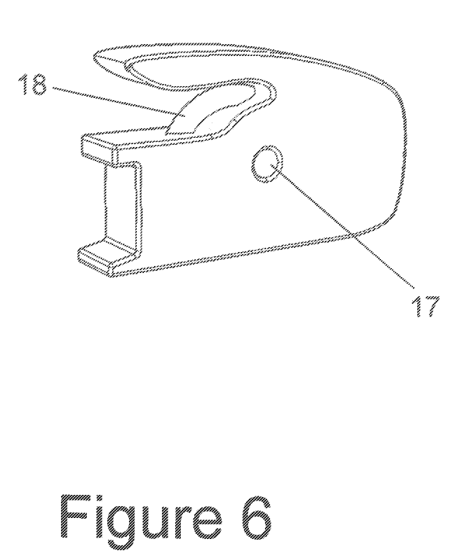

As shown in FIG. 6, there is located a knife 18 inside of the magnetic knife in FIG. 6. Through the knife, a fisherman could cut an unnecessary fishing line without using a general fishing knife in the market while “Attached Apparatus” is attached to his fishing jacket or clothing through magnetic button 4, 5, 6, by putting the unnecessary fishing line into the knife 18 in the magnetic knife.

The magnetic button set 3 is located in the upper back part of the “Attachable Apparatus.” It consists of a plus pole magnet 6 fixed on the button 4 and a minus pole magnet 5 fixed on the back of “Attachable Apparatus”

The magnetic button set allows a fisherman to attach “Attachable Apparatus” to his clothing or jacket by placing the clothing or jacket between the plus pole magnet and the minus pole magnet.

The pullable plate 10 with the fishing hook attached on is located in the lower front part of “Attachable Apparatus”, which is connected to the upper part of “Attachable Apparatus” through two flexible strings 8, 9.

It permits a fisherman to pull out the pullable plate 10 with the fishing hook depot attached while “Attachable Apparatus” is still attached to his fishing clothing or jacket during his fishery so that he could easily draw out a fishing hook depot in order to replace the used fishing hook with a new fishing hook.

The fishing hook depot 16 is placed on the pullable plate 14 by the help of one magnetic set 15, 20 and two connectable hooks 13 which would be hooked into two holes located in the upper part of the pullable plate 14.

The fishing hook depot 16 is freely detachable from the pullable plate so that a fisherman could easily refill the fishing hook depot with new fishing hooks where there is no fishing hook left in the hook depot while “Attachable Apparatus” is still attached to his fishing clothing or jacket. cm What is claimed is:

1. Attachable apparatus for fishing hook depot (denoted as below, “Attachable Apparatus”) comprises as follows:
First, a magnetic button;
Second, a magnetic knife;
Third, a pullable plate with a fishing hook depot attached on; and
Fourth, a fishing hook depot with two connecting hooks and one magnetic set attached.

2. The magnetic button of claim 1, wherein the magnetic button is located in the upper back part of the Attachable Apparatus.

3. The magnetic button of claim 1, wherein it comprises a plus pole magnet and a minus pole magnet and a magnetic button permit a fisherman to attach it to his clothing or jacket by placing his clothing or jacket between the plus pole magnet and the minus pole magnet.

4. The magnetic knife of claim 1, wherein it is located inside the hole which is located in the front upper part of the Attachable Apparatus.

5. The magnetic knife of claim 1, wherein it comprises a knife and one magnetic set, wherein one magnet is in the middle of the magnetic knife and the other magnet is in the squared space on the left wall inside the hole located in the front upper part of Attachable Apparatus.

6. The magnetic knife of claim 1 permits a fisherman to cut an used fishing line by putting it into the magnetic knife while he is fishing with the “Attachable Apparatus” attached to his fishing jacket.

7. The pullable plate with a fishing hook depot attached on of claim 1, wherein it is located in the lower front part of the “Attachable Apparatus” and it comprises a pullable plate and two flexible strings which are connected to the front upper part of Attachable Apparatus.

8. The pullable plate with a fishing hook depot attached on of claim 1 permits a fisherman to pull the pullable plate with a fishing hook depot attached on, while he is fishing with the “Attachable Apparatus” attached to his fishing jacket, in order to easily replace an used fishing hook with a new fishing hook.

9. The fishing hook depot with two connecting hooks and one magnetic set attached of claim 1, wherein it is placed on the pullable plate and it comprises two connecting hooks and one magnetic set.

10. Two connecting hooks in claim 9, wherein they are located in the upper part of the fishing hook depot and would be hooked into two holes located in the upper part of pullable plate in claim 8.

11. One magnetic set in claim 9, wherein a plus pole magnet is located in the middle back of fishing hook depot and a minus pole magnet is located in the front middle of the pullable plate.

12. The fishing hook depot with two connecting hooks and one magnetic set attached of claim 1 permits a fisherman to take out the fishing hook depot from the pullable plate in claim 7 and easily refill the new fishing hooks in the empty depot while he is fishing with Attachable Apparatus attached to his jacket.
